(19) United States
(12) Patent Application Publication
(10) Pub. No.: US 2025/0383940 A1
(43) Pub. Date: Dec. 18, 2025

(54) ELECTRONIC DEVICE CONTROL METHOD AND ELECTRONIC DEVICE

(71) Applicant: MEDIATEK INC., Hsinchu City (TW)

(72) Inventors: Yen-Po Chien, Hsinchu City (TW); Yen-Sheng Wang, Hsinchu City (TW); Nien-Hsien Lin, Hsinchu City (TW); Liang-Syuan Huang, Hsinchu City (TW); Cheng-Han Tsai, Hsinchu City (TW); Cheng-Che Chen, Hsinchu City (TW)

(73) Assignee: MEDIATEK INC., Hsinchu City (TW)

(21) Appl. No.: 19/221,560

(22) Filed: May 29, 2025

Related U.S. Application Data
(60) Provisional application No. 63/659,957, filed on Jun. 14, 2024.

(51) Int. Cl. G06F 9/50

(52) U.S. Cl. CPC G06F 9/5083; G06F 9/5038; G06F 2209/501

(57) ABSTRACT

An electronic device control method, for controlling an electronic device with a plurality of processing cores and installed with an application, comprising: (a) the application creating a plurality of worker threads which are respectively processed by the processing cores; (b) the application dispatches works with initial workloads to the worker threads respectively; (c) computing suggested workloads respectively for the worker threads based on system information of the electronic device; and (d) the application dispatching works with adjusted workloads to the worker threads according to the suggested workloads.

### CROSS REFERENCE TO RELATED APPLICATIONS

This application claims the benefit of U.S. Provisional Application No. 63/659,957, filed on Jun. 14, 2024. The content of the application is incorporated herein by reference.

### BACKGROUND

The present application relates to an electronic device control method and an electronic device, and particularly relates to an electronic device control method and an electronic device which can dispatch works to worker threads according to real time condition of the electronic device.

In recent years, mobile electronic devices have become increasingly popular, and therefore software vendors have developed a variety of third-party applications that can be used by mobile electronic devices. Users usually install various third-party applications with different functions on their mobile electronic devices. However, since the developers of these third-party applications are usually different from the developers of the mobile electronic device, some information of the mobile electronic device could not be acquired by the third-party applications.

Therefore, the performance of the mobile electronic device is often not optimized when the mobile electronic device executes these third-party applications. For example, the CPU cores in each mobile electronic device generally have different computing powers. However, third-party applications may not acquire such information, thereby making processing performance of the CPU cores of the mobile electronic device non-optimal.

Accordingly, a new mechanism is needed to improve these problems.

### SUMMARY

One objective of the present application is to provide an electronic device control method which can optimize the working performance of the electronic device according to real time information.

Another objective of the present application is to provide an electronic device which can optimize the working performance of the electronic device according to real time information.

One embodiment of the present application discloses an electronic device control method, for controlling an electronic device with a plurality of processing cores and installed with an application, comprising: (a) the application creating a plurality of worker threads which are respectively processed by the processing cores; (b) the application dispatches works with initial workloads to the worker threads respectively; (c) computing suggested workloads respectively for the worker threads based on system information of the electronic device; and (d) the application dispatching works with adjusted workloads to the worker threads according to the suggested workloads.

Still another embodiment of the present application discloses: an electronic device control method, for controlling an electronic device with a first processing core, a second processing core and installed with an application, comprising: (a) the application creating a first worker thread processed by the first processing core and a second worker thread processed by the second processing core; (b) the application respectively dispatching works with a first initial workload to the first worker thread and works with a second initial workload to the second worker thread; (c) computing a first suggested workload for the first worker thread based a processing result of the first processing core which processes the works with the first initial workload; (d) computing a second suggested workload for the second worker thread based a processing result of the second processing core which processes the works with the second initial workload; and (e) the application dispatching works with adjusted workloads to the first worker thread and the second worked thread according to the first suggested workload and the second suggested workload.

Still another embodiment of the present application discloses an electronic device, comprising: a plurality of processing cores; a storage device; and a processing circuit, configured to perform following steps: wherein an application is installed to the electronic device, the application creates a plurality of worker threads which are respectively processed by the processing cores, and the application dispatches works with initial workloads to the worker threads respectively; wherein suggested workloads are computed respectively for the worker threads based on system information of the electronic device; wherein the application dispatches works with adjusted workloads to the worker threads according to the suggested workloads.

In view of above-mentioned embodiments, the workloads of works processed by the electronic device may be adjusted according to real time information thereof. By this way, the working performance of the electronic device may still be optimized while executing a third-party application.

These and other objectives of the present application will no doubt become obvious to those of ordinary skill in the art after reading the following g detailed description of the preferred embodiment that is illustrated in the various figures and drawings.

### BRIEF DESCRIPTION OF THE DRAWINGS

FIG. 1 is a schematic diagram illustrating operations of the application and the electronic device, according to one embodiment of the present application.

FIG. 2, FIG. 3 and FIG. 4 are schematic diagrams illustrating the steps of dispatching works according to different embodiments of the present application.

FIG. 5 and FIG. 6 are flow charts illustrating summarized steps of the electronic device control methods, according to different embodiments of the present application.

FIG. 7 is a block diagram illustrating an electronic device according to one embodiment of the present application.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

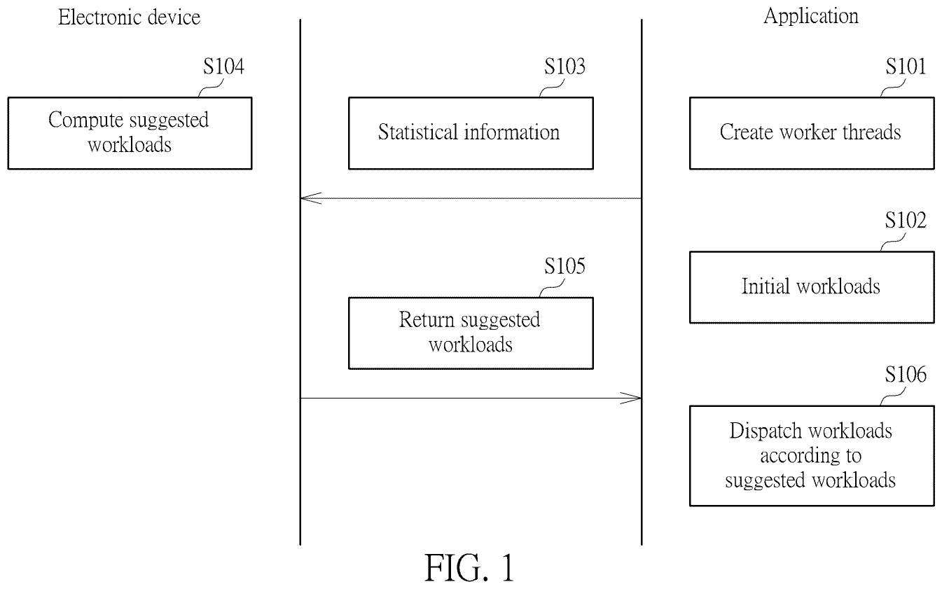

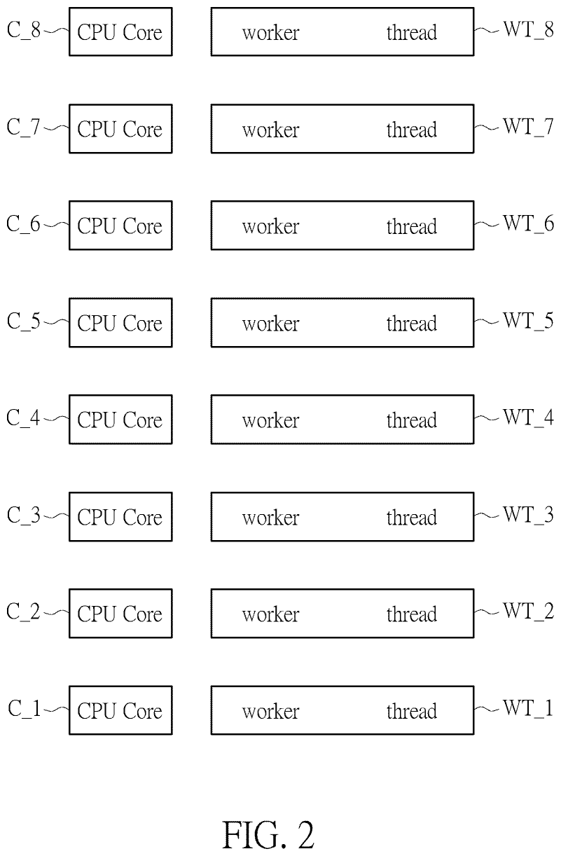

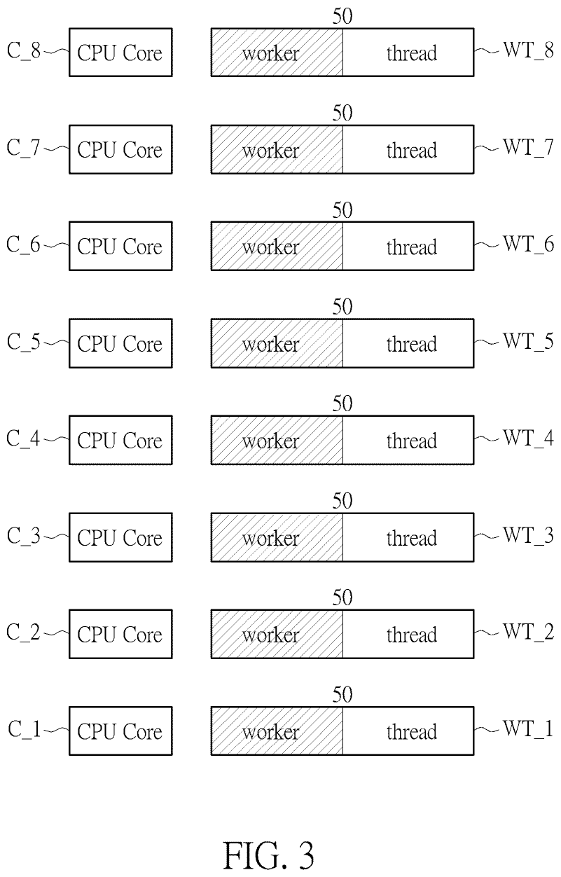

FIG. 1 is a schematic diagram illustrating operations of the application and the electronic device, according to one embodiment of the present application. FIG. 2, FIG. 3 and FIG. 4 are schematic diagrams illustrating the steps of dispatching works according to different embodiments of the present application. Please also refer to FIGS. 2, 3, 4 while referring to FIG. 1, to understand the contents of the present application for more clear. The communication between the application and the electronic device may be implemented by various interfaces, such as an API (Application Programming Interface).

In the step S101 of FIG. 1, the application which is installed to an electronic device creates worker threads, which may comprise a plurality of works (or named tasks) to be processed. The application may be a third-party application. In one embodiment, the worker threads are respectively processed by different CPU cores of the electronic device. For example, in FIG. 2, the application creates worker threads WT_1 . . . WT_8 which are respectively processed by CPU cores C_1 . . . C_8. Please note, the CPU cores C_1 . . . C_8 can be replaced by any other processing cores, which can be devices or circuits.

In the step S102 of FIG. 1, the application dispatches works with initial workloads to the worker threads respectively. For example, in the embodiment of FIG. 3, the application dispatches works with initial workloads 50 to the worker threads WT_1 . . . WT_8 respectively. That is, the initial workloads are evenly distributed. Please note, in the embodiment of FIG. 3, the initial workloads for different one of the worker threads WT_1 . . . WT_8 are identical (50 in this example). However, in another example, the initial workloads for different one of the worker threads WT_1 . . . WT_8 are different. For example, in one embodiment, the initial workloads for different one of the worker threads WT_1 . . . WT_8 are respectively (100, 100, 80, 80, 70, 60, 50, 40). The higher the workload value, the higher the computing power required for processing the corresponding works.

In the step S103, the application provides statistical information related with works, such as work types or the workload of each of the worker threads to the electronic device. In the step S104 in FIG. 1, suggested workloads respectively for the worker threads are computed based on system information of the electronic device. In one embodiment, the system information comprises: a number of the worker threads, the initial workloads, a current system load, or current frequencies of the CPU cores. For example, the system information comprises the current system load and the current frequencies of the CPU cores. For another example, the system information comprises the number of the worker threads and the initial workloads. In one embodiment, the system information is collected when the worker threads with the initial workloads are processed, such that the collected system information reflects the utilization of the initial workloads.

As shown in the embodiment of FIG. 4, the suggested workloads are respectively (70, 40, 40, 40, 5, 8, 2, 2). That is, the suggested workloads are unevenly distributed. Please note, in the embodiment of FIG. 1, the step S104 is performed by an OS (operation system) of the electronic device. However, in another embodiment, the step S104 may be performed by the application, if the application can acquire sufficient information from the electronic device.

Next, in the step S105, the electronic device returns suggested workload to the application. As above-mentioned, the step S104 may be performed by the application, if the application can acquire sufficient information from the electronic device. In such case, the steps S103 and S105 may be omitted. Afterwards, in the step S106, the application dispatches works according to the suggested workloads. For example, the application assigns works which respectively have suggested workloads (70, 40, 40, 40, 5, 8, 2, 2) to the worker threads WT_1 . . . WT_8 in the step S106. The steps S103 . . . S106 may be repeated to optimize the working performance of the CPU cores.

In one embodiment, the CPU cores comprise a first core and a second CPU core, and a performance capability of the first core is greater than a performance capability of the second core. In other words, the first core and the second core are respectively a big core and a little core, or named as a P-core and an E-core. In such case, the step S104 is inclined to prioritize the works to the second core. In other words, the step S104 assigns the work with the largest workload to the first core as much as possible. For example, in the embodiment of FIG. 4, the CPU cores C_5 . . . C_8 are big cores, and the CPU cores C_1 . . . C_4 are small cores. Accordingly, the suggested workloads for the CPU cores C_5 . . . C_8 are larger (70, 40, 40, 40), and the suggested workloads for the CPU cores C_1 . . . C_4 are smaller (2, 2, 8, 5).

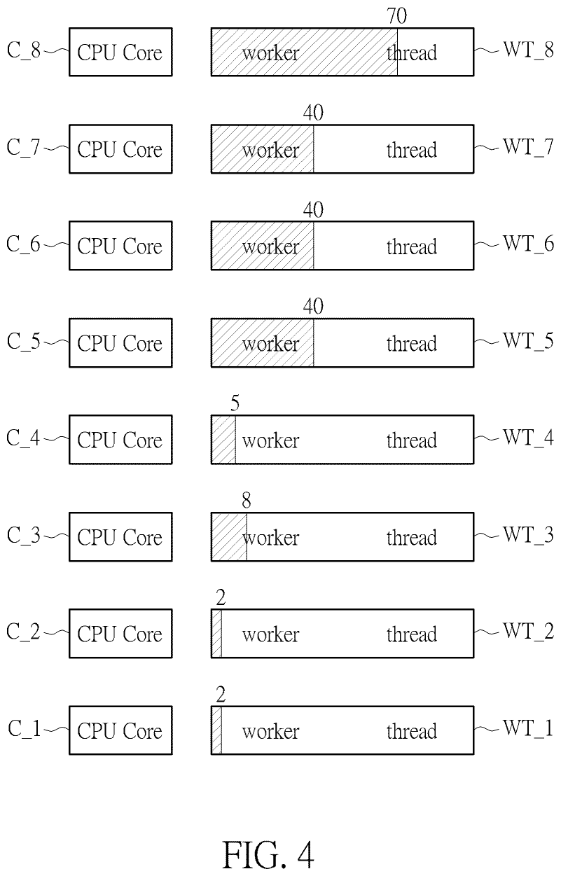

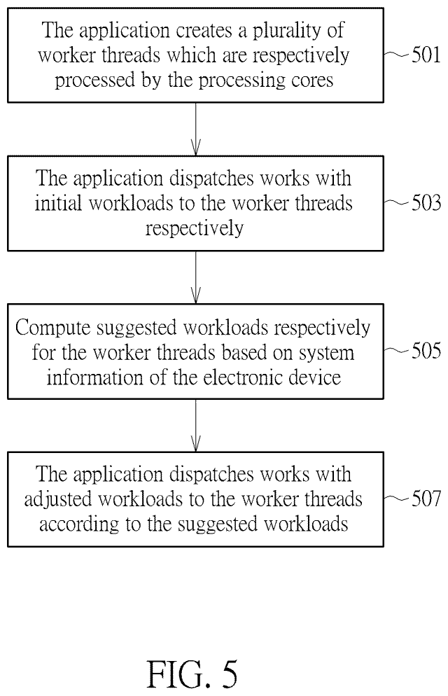

In view of above-mentioned embodiments, electronic device control methods with summarized steps can be acquired. FIG. 5 is a flow chart illustrating summarized steps of the electronic device control methods, according to one embodiment of the present application. The electronic device control method shown in FIG. 5 is for controlling an electronic device with a plurality of processing cores (e.g., CPU cores) and installed with an application. The flow chart in FIG. 5 comprises:

### Step 501

The application creates a plurality of worker threads which are respectively processed by the processing cores.

For example, as shown in FIG. 1, the application creates worker threads WT_1 . . . WT_8 which are respectively processed by CPU cores C_1 . . . C_8.

### Step 503

The application dispatches works with initial workloads to the worker threads respectively.

For example, as illustrated in the step S102, the application dispatches works with initial workloads to the worker threads WT_1 . . . WT_8. As above-mentioned, the initial workloads for different worker threads may be identical or be different.

### Step 505

Compute suggested workloads respectively for the worker threads based on system information of the electronic device.

For example, in the step S104, the electronic device computes suggested workloads respectively for the worker threads WT_1 . . . WT_8 based on system information of the electronic device.

As above-mentioned, the step S104 may be performed by the application rather than limited to be performed by the electronic device.

### Step 507

The application dispatches works with adjusted workloads to the worker threads according to the suggested workloads.

For example, as stated in the step S106, the application dispatches works to the worker threads WT_1 . . . WT_8 according to the suggested workloads (70, 40, 40, 40, 5, 8, 2, 2).

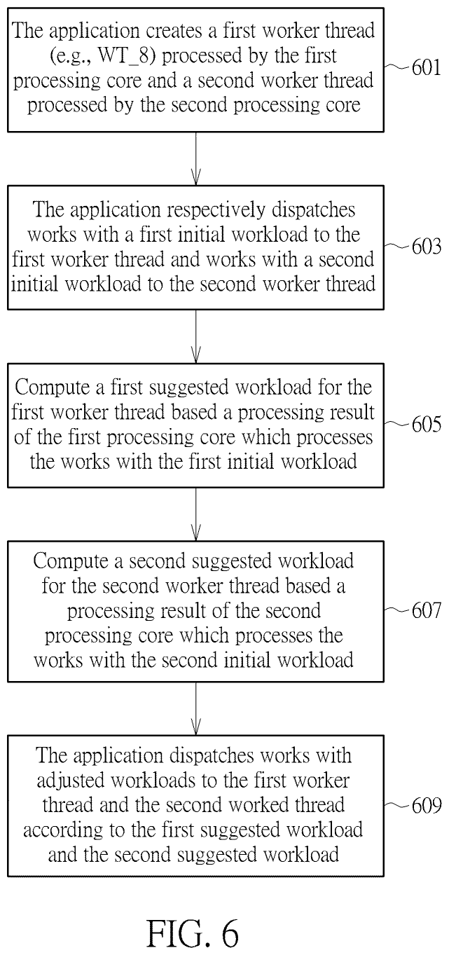

FIG. 6 is a flow chart illustrating summarized steps of the electronic device control method, according to another embodiment of the present application. The flowchart of FIG. 6 describes the electronic device control method provided by the present application in a different manner from the flowchart of FIG. 5. The method illustrated in FIG. 6 is used for controlling an electronic device with a first processing core (e.g., the CPU core C_8, but not limited), a second processing core (e.g., the CPU core C_1, but not limited) and installed with an application. In such case, a computing power of the first processing core is better than a computing power of the second processing core.

The flow chart in FIG. 6 comprises:

### Step 601

The application creates a first worker thread (e.g., WT_8) processed by the first processing core and a second worker thread (e.g., WT_1) processed by the second processing core.

### Step 603

The application respectively dispatches works with a first initial workload to the first worker thread and works with a second initial workload to the second worker thread.

For example, as illustrated in the step S102, the application dispatches works with a first initial workload to the worker thread WT_8 and works with a second initial workload to the worker thread WT_1.

As above-mentioned, the first initial workload and the second initial workload may be identical or be different.

### Step 605

Compute a first suggested workload for the first worker thread based a processing result of the first processing core which processes the works with the first initial workload.

For example, in the embodiment of FIG. 4, the first suggested workload for the first worker thread WT_8 is 70.

### Step 607

Compute a second suggested workload for the second worker thread based a processing result of the second processing core which processes the works with the second initial workload.

For example, in the embodiment of FIG. 4, the second suggested workload for the second worker thread WT_1 is 2.

### Step 609

The application dispatches works with adjusted workloads to the first worker thread and the second worked thread according to the first suggested workload and the second suggested workload.

Other details steps of the embodiments shown in FIG. 5 and FIG. 6 can be acquired based on the above-mentioned embodiments, thus are omitted for brevity here.

The above-mentioned electronic device control methods may be performed by any electronic device.

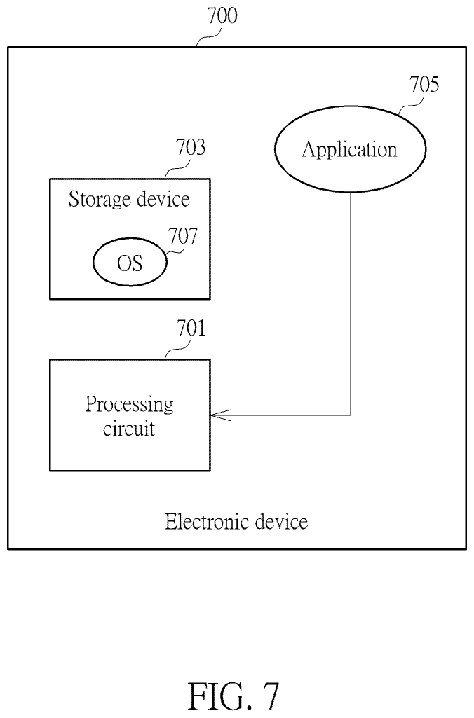

FIG. 7 is a block diagram illustrating an electronic device according to one embodiment of the present application. As illustrated FIG. 7, the electronic device 700 comprises a processing circuit 701 and a storage device 703. Please note, the storage device 703 may be provided inside the electronic device 700, but may be provided outside the electronic device 700 as well. Also, an application 705 is installed to the electronic device 700. The application 705 may be installed to the storage device 703, but may be installed to another storage device. The processing circuit 701 is configured to execute at least one program in the storage device 703 to execute the OS 707 and to perform the above-mentioned embodiments together with the application program 705. In one embodiment, the processing circuit 701 is a CPU which may comprise a plurality of CPU cores such as the CPU cores C_1 . . . C_8 in FIG. 2-FIG. 4.

In view of above-mentioned embodiments, the workloads of works processed by the electronic device may be adjusted according to real time information thereof. By this way, the working performance of the electronic device may still be optimized while executing a third-party application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device control method, for controlling an electronic device with a plurality of processing cores and installed with an application, comprising:
(a) the application creating a plurality of worker threads which are respectively processed by the processing cores;
(b) the application dispatches works with initial workloads to the worker threads respectively;
(c) computing suggested workloads respectively for the worker threads based on system information of the electronic device; and
(d) the application dispatching works with adjusted workloads to the worker threads according to the suggested workloads.

2. The electronic device control method of claim 1, wherein the system information is collected when the worker threads with the initial workloads are processed.

3. The electronic device control method of claim 2,
wherein the initial workloads are evenly distributed, and the suggested workloads are unevenly distributed based on the system information.

4. The electronic device control method of claim 1, wherein the step (c) is performed by an OS (operation system) of the electronic device or by the application.

5. The electronic device control method of claim 1, wherein the system information comprises: a number of the worker threads, the initial workloads, a current system load, or current frequencies of the processing cores.

6. The electronic device control method of claim 1, wherein the processing cores are CPU cores.

7. The electronic device control method of claim 6,
wherein the processing cores comprise a first core and a second core, and a performance capability of the first core is greater than a performance capability of the second core;
wherein the step (c) is inclined to prioritize the works to the second core.

8. An electronic device control method, for controlling an electronic device with a first processing core, a second processing core and installed with an application, comprising:
(a) the application creating a first worker thread processed by the first processing core and a second worker thread processed by the second processing core;
(b) the application respectively dispatching works with a first initial workload to the first worker thread and works with a second initial workload to the second worker thread;
(c) computing a first suggested workload for the first worker thread based a processing result of the first processing core which processes the works with the first initial workload;
(d) computing a second suggested workload for the second worker thread based a processing result of the second processing core which processes the works with the second initial workload; and
(e) the application dispatching works with adjusted workloads to the first worker thread and the second worked thread according to the first suggested workload and the second suggested workload.

9. The electronic device control method of claim 8, wherein the system information is collected when the worker threads with the initial workloads are processed.

10. The electronic device control method of claim 9,
wherein the initial workloads are evenly distributed, and the suggested workloads are unevenly distributed based on the system information.

11. The electronic device control method of claim 8, wherein the steps (c) and (d) are performed by an OS (operation system) of the electronic device or by the application.

12. The electronic device control method of claim 8,
wherein the system information comprises: a number of the worker threads, the first initial workload, the second initial workload, a current system load, or current frequencies of the first core, the second core.

13. The electronic device control method of claim 8, wherein the first processing core and the second processing core are CPU cores.

14. The electronic device control method of claim 13,
wherein a performance capability of the first core is greater than a performance capability of the second core;
wherein the step (c) and the step (d) are inclined to prioritize the works to the second core.

15. An electronic device, comprising:
a plurality of processing cores;
a storage device; and
a processing circuit, configured to perform following steps:
wherein an application is installed to the electronic device, the application creates a plurality of worker threads which are respectively processed by the processing cores, and the application dispatches works with initial workloads to the worker threads respectively;
wherein suggested workloads are computed respectively for the worker threads based on system information of the electronic device;
wherein the application dispatches works with adjusted workloads to the worker threads according to the suggested workloads.

16. The electronic device of claim 15, wherein the system information is collected when the worker threads with the initial workloads are processed.

17. The electronic device of claim 16,
wherein the initial workloads are evenly distributed, and the suggested workloads are unevenly distributed based on the system information.

18. The electronic device of claim 15, wherein the processing circuit executes an OS (operation system) of the electronic device to compute the suggested workloads, or the suggested workloads are computed by the application.

19. The electronic device of claim 15, wherein the system information comprises: a number of the worker threads, the initial workloads, a current system load, or current frequencies of the processing cores.

20. The electronic device of claim 15, wherein the processing cores are CPU cores.

21. The electronic device of claim 20,
wherein the processing cores comprise a first core and a second core, and a performance capability of the first core is greater than a performance capability of the second core;
wherein the processing circuit is inclined to prioritize the works to the second core.
